(19) United States
(12) Patent Application Publication
(10) Pub. No.: US 2005/0129306 A1
(43) Pub. Date: Jun. 16, 2005

(54) Method and apparatus for image deinterlacing using neural networks

(76) Inventors: Xianglin Wang, Santa Ana, CA (US); Yeong-Taeg Kim, Irvine, CA (US)

Correspondence Address: Kenneth L. Sherman;MYERS DAWES ANDRAS & SHERMAN, LLP, 19900 MacArthur Blvd., Suite 1150, Irvine, CA, 92612, US

(21) Appl. No.: 10/735,230

(22) Filed: Dec. 12, 2003

(51) Int. Cl. G06K 9/62; G06K 9/32

(52) U.S. Cl. 382/156; 382/300

(57) ABSTRACT

A method for interpolating an omitted scan line between two neighboring scan lines of an interlaced image includes detecting an edge direction of the image at a selected point on the omitted scan line, selecting a neural network based upon the detected edge direction, and using the neural network to provide an interpolated value for the selected point.

### FIELD OF THE INVENTION

The present invention relates generally to video imaging. The present invention relates more particularly to a method for deinterlacing a video image by interpolating omitted scan lines of an interlaced video field through the use of neural networks which are selected based upon edge directions of the video image.

### BACKGROUND OF THE INVENTION

Interlaced video images for presentation upon televisions and video monitors are well known. Interlacing is a process used in televisions and monitors which operate according to the National Television System Committee (NTSC) and Phase Alternation by Line (PAL) standards, for example.

An interlaced image comprises multiple lines, such that when an interlaced image is displayed, odd numbered lines of the image are typically first formed from the top to the bottom of the screen and then the alternating even numbered lines are formed in a similar fashion. In this manner, a single frame or image is split into two consecutively displayed fields.

Interlacing was first introduced into television systems because of the limited bandwidth available in the television broadcasting portion of the radio frequency spectrum. As those skilled in the art will appreciate, interlaced images require substantially less radio frequency bandwidth for broadcasting than non-interlaced images.

However, in modern computer displays and televisions, bandwidth does not impose such a limitation. Many viewers believe that non-interlaced video is visually superior to interlaced video. And, some viewers perceive greater resolution and less flicker in non-interlaced video images. Therefore, non-interlaced video is frequently preferred.

For example, in a digital TV system where images are typically displayed in a non-interlaced format, the input video may have many different formats and thus can be either interlaced or non-interlaced. In order to display non-interlaced images, a deinterlacing process is used for converting an interlaced image into a non-interlaced image. Also, it is frequently desirable to display video images upon a computer monitor in a non-interlaced format. Thus, if the input video signal is interlaced, it is necessary to convert the input video signal to a non-interlaced format.

In order to deinterlace an interlaced video image field, “missing” scan lines of a field (such as the even scan lines) between the “present” scan lines of the field present (such as the odd scan lines), must be provided.

Various methods may be used to provide the missing scan lines. Conventional methods for deinterlacing interlaced video images include line doubling, spatial interpolation and a combination of spatial and temporal interpolation. When line doubling method is used, a given scan line is merely copied so as to provide the corresponding, i.e., neighboring, missing scan line. However, this method does not generally provide very satisfactory results. The actual resolution of a deinterlaced image formed by line doubling is no better than that of the original interlaced image. The perceived or apparent resolution of such a deinterlaced image is typically only slightly better than that of the original interlaced image.

When spatial interpolation is used for deinterlacing, an attempt is made to form the missing scan lines using information contained in the present scan lines. Thus, in spatial interpolation, only samples in the same field are utilized to estimate the values for new pixels to form the missing scan lines (otherwise some amount of temporal interpolation is involved).

Therefore, the value of a new pixel is estimated based on the values of its neighboring pixels, due to the correlation among neighboring sample values in an image field. Generally, interpolation is performed by computing a weighted average of neighboring sample values as the interpolation value for the new pixel.

For example, to form a pixel which is on a missing scan line, the values (such as the luminance or color values) of pixels adjacent the missing pixel on the present scan lines is averaged. The pixels closer to the missing pixel are given more weight in the averaging process than pixels farther from the missing pixel. The averaged values approximate the desired value of the missing pixel prior to interlacing of the image. Thus, the interpolation process attempts to recreate the original, non-interlaced image.

Similarly, temporal interpolation attempts to form the missing scan lines using information from fields which precede and/or follow the field with the missing scan lines. As such, the value of a missing pixel may be the averaged values of the pixel from the same location in fields which precede/follow the field containing the missing pixel. For example, the values of corresponding pixels from two odd fields can be averaged to provide the missing value for a pixel in an even field therebetween.

Moreover, temporal information alone does not always provide acceptable interpolation results. As such, when temporal information is inadequate, spatial interpolation is frequently used. Thus, regardless of the type of image interpolation used, a good spatial interpolation method is essential in achieving desired overall video deinterlacing quality in such applications as digital TV systems.

Conventional image interpolation methods which use both spatial and temporal information simultaneously for deinterlacing a video sequence, are referred to as spatio-temporal methods.

Although conventional interpolation methods have proven generally suitable for their intended purposes, one commonly encountered problem is the undesirable degradation of image edges. This is frequently observed as serrated lines or blurred edges that may appear in the interpolated or deinterlaced image. This degradation results in the familiar stair step effect frequently seen in the diagonal edges of video images.

To mitigate such image degradation, some conventional methods interpolate a new pixel along an edge direction that is detected at the position of the new pixel. If a valid edge direction is detected at a new pixel location, the value of the pixel is interpolated as a weighted average of neighboring sample values only along that edge direction. As a result, the edge in the interpolated image is smoother along the edge direction and sharper across the edge direction. Thus, edge quality is better preserved in the interpolated image.

However, such conventional interpolation methods require that edge direction be accurately detected. If an edge direction is detected erroneously or inaccurately, interpolating along that direction may introduce obvious artifacts into the interpolated image. Further, contemporary edge direction detection methods are inherently less accurate than desired.

As such, although the prior art has recognized, to a limited extent, the problem of accurately deinterlacing a video image, the proposed solutions have, to date, been ineffective in providing a satisfactory remedy. Therefore, it is desirable to provide a method and apparatus for deinterlacing a video image which more closely approximates the original, non-interlaced image. It is particularly desirable to provide a robust method for interpolating images wherein image quality is maintained even when edge detection is inaccurate.

### BRIEF SUMMARY OF THE INVENTION

The present invention addresses the above mentioned deficiencies associated with the prior art. In one embodiment the present invention provides a method for spatially interpolating an image, by training a neural network to interpolate for an edge direction and then using that neural network to interpolate when approximately the same edge direction in an image is determined.

According to another embodiment, the present invention provides a method for spatially interpolating an image, by associating a plurality of neural networks with a corresponding plurality of edge directions by training each neural network for interpolation based upon the associated edge direction.

According to another embodiment, the present invention provides a method for spatially interpolating an image, by determining an edge direction of an image at a location within the image where interpolation is desired, selecting a neural network based upon the determined edge direction, and interpolating a value of the image at the location using the selected neural network.

Preferably, determining an edge direction comprises determining vector correlations between pixels on adjacent scan lines wherein the location where interpolation is desired is between the adjacent scan lines.

The method preferably further comprises determining whether or not a viable edge direction exists prior to selecting a neural network and when no viable edge direction exists, then selecting a neural network which was trained to interpolate when no viable edge direction exists.

Selecting a neural network preferably comprises determining which of a plurality of different neural networks is trained and associated with the determined edge direction.

Yet in another version, selecting a neural network preferably comprises mirroring a data set to facilitate use of a common neural network for symmetric edge directions. The data set is preferably vertically mirrored. In this manner, the number of neural networks required is approximately cut in half.

Still in another version, selecting a neural network preferably comprises selecting a substantially linear neural network with one neuron. However, various types of neural networks, including non-linear neural networks, are likewise suitable. Each neural network may alternatively comprise any desired number of neurons.

Preferably, a plurality of neural networks are trained so as to facilitate more accurate and reliable interpolation. Each neural network is preferably trained to interpolate a value of an image for a predetermined edge direction. Thus, according to an embodiment of the present invention, each neural network is optimized so as to best interpolate a value of an image at a location of the image where a given edge direction exists. In this manner, each one of a plurality of different neural networks is associated with a particular edge direction and is best suited for interpolation of an image value where that edge direction exists within the image.

The aforementioned determining, selecting and interpolating steps may be repeated as desired, so as to provide a new scan line between two old scan lines, for example. Thus, a method for image interpolation according to the present invention may be used for deinterlacing, for example. Alternatively, a method for image interpolation according to the present invention may be used for image resolution enhancement (or image up-scaling) other than deinterlacing.

The present invention may be used for different types of images, and thus is not limited to use with video images.

Preferably, the location of the video image which is interpolated is defined by a pixel. The interpolated value may be intensity, color, or any other value for which such interpolation is beneficial.

Preferably, the edge direction is determined by correlating a vector from one scan line proximate the location where interpolation is desired with another scan line proximate the location where interpolation is desired. Said scan lines immediately above and below the location where interpolation is desired.

The location where interpolation is desired may be between two scan lines of a video image. This will generally be the case when the present invention is used for deinterlacing. Thus, the location may be between two scan lines of a field of an interlaced video image.

When the present invention is used for deinterlacing, the location where interpolation is desired is approximately centered between two scan lines of an interlaced video image. Thus, during deinterlacing, the present invention may facilitate interpolation of substantially an entire missing scan line.

Inputs to the selected neural network, i.e., that neural network which is interpolating an image value, comprise corresponding values of neighboring portions of the image with respect to the location where interpolation is desired. As such, if intensity is being interpolated, then intensity values of neighboring portions of the image are provided as inputs to the selected neural network. The inputs preferably comprise values of neighboring pixels with respect to a pixel at the location where interpolation is desired.

Determining an edge direction preferably comprises determining one of 2N+1 different edge directions and selecting a neural network preferably comprises selecting one of N+3 neural networks. More particularly, N+1 of the neural networks are preferably used for interpolation when an edge direction can be determined. Further, one of the neural networks is preferably used for interpolation when an edge exists and the edge direction cannot be determined. And one neural network is used when there is no discernable edge.

Preferably, 40 to 80 samples, and more preferably 60 samples, are provided as inputs to the neural network. Each sample comprises a value of the image taken from a location within the image which is proximate the location where interpolation is desired. Each location is preferably a pixel.

The neural network is trained by providing at least a portion of an image to it. A bias value of the neural network is initially set to zero when training begins. All of the inputs to the neural network are given even weighting when training begins.

Alternatively, the bias may be set to a value other than zero and/or the weighting factors may be other than even when training begins. This may be done, for example, when particular starting values for these parameters are known which enhance the training process, such as by speeding up the training process or such as by making interpolation more accurate after the training process is complete.

The image, or portion thereof, provided during the training process is preferably low pass filtered so as to mitigate components thereof, which are substantially beyond a capability of the neural network to interpolate.

The cut-off frequency of the low pass filter is preferably approximately one fourth of a sampling frequency of the image.

A back propagation algorithm is used to vary parameters of the neural network during the training process. The parameters include the weighting factors and/or a bias value. The back propagation algorithm preferably uses a least mean square procedure as a learning algorithm.

According to another embodiment, the present invention provides a system for spatially interpolating an image, comprising a plurality of neural networks, each neural network configured to interpolate a value of the image for a predetermined edge direction; an edge direction detector configured to determine an edge direction of an image at a location within the image where interpolation is desired; and a neural network selector responsive to the edge direction detector and configured to select one of the neural networks based upon the determined edge direction.

The edge direction detector is configured to determine an edge direction by determining vector correlations between pixels on adjacent scan lines. The edge direction detector is configured to determine if a viable edge direction exists prior to selecting a neural network and when no viable edge direction exists then selecting a neural network which was trained to interpolate when no viable edge direction exists.

The neural network selector is configured to select a neural network by determining which of a plurality of different neural networks is trained and associated with the determined edge direction.

The edge direction detector is configured to determine an edge direction by correlating at a vector from one scan line proximate the location where interpolation is desired, with another scan line proximate that location. Said scan lines are preferably immediately above and below the location where interpolation is desired.

According to another embodiment, the present invention provides a method for interpolating an omitted scan line between two neighboring scan lines of an interlaced image, by: detecting an edge direction of the image at a selected point on the omitted scan line, selecting a neural network based upon the detected edge direction, and using the neural network to provide an interpolated value for the selected point.

According to another embodiment, the present invention provides a method for deinterlacing a video image, by: determining an edge direction of a video image at a location within the video image where interpolation is desired. The location is preferably intermediate two adjacent scan lines of a field of the video image. A neural network based upon the determined edge direction is selected and a value of the video image at the location is interpolated using the selected neural network. This process is repeated so as to provide a new scan line between two old scan lines.

According to another embodiment, the present invention provides a device for interpolating a missing line between two neighboring scan lines of an interlaced image, comprising an edge detector configured to detect an edge direction of the image at a selected point on the omitted line and a plurality of neural networks. Each neural network is preferably configured to interpolate a value for the omitted line when a particular edge direction has been detected.

According to another embodiment, the present invention comprises a system for deinterlacing a video image, comprising a plurality of neural networks. Each neural network is configured to interpolate a value of the video image for a predetermined edge direction. An edge direction detector is configured to determine an edge direction of an image at a location within the video image where interpolation is desired. A neural network selector is responsive to the edge direction detector and configured to select one of the neural networks based upon the determined edge direction.

According to another embodiment, the present invention provides a monitor, wherein the monitor comprising a system for deinterlacing a video image, comprising: a plurality of neural networks, each neural network configured to interpolate a value of the video image for a predetermined edge direction; an edge direction detector configured to determine an edge direction of an image at a location within the video image where interpolation is desired; and a neural network selector responsive to the edge direction detector and configured to select one of the neural networks based upon the determined edge direction.

According to another embodiment, the present invention provides an image generated by a method for spatial interpolation, including the steps of: determining an edge direction of an image at a location within the image where interpolation is desired, selecting a neural network based upon the determined edge direction, and interpolating a value of the image at the location using the selected neural network.

According to another embodiment, the present invention provides a deinterlaced video image produced by a method for deinterlacing, wherein the method for deinterlacing comprises: determining an edge direction of an interlace video image at a location within the image intermediate two adjacent scan lines of a field of the video image, selecting a neural network based upon the determined edge direction, and interpolating a value of the video image at the location using the selected neural network.

According to another embodiment, the present invention provides a method for training a neural network, comprising the steps of: providing a non-interlaced image, interlacing the image to form an interlaced image; providing at least a portion of the interlaced image to the neural network, determining an edge direction of the interlaced image at a location within the interlaced image, selecting a neural network based upon the determined edge direction, interpolating a value of the interlaced image at the location using the selected neural network, comparing the interpolated value with a value from a corresponding location of the non-interlaced image to define an error value, and modifying the selected neural network based upon the error value.

Preferably, the non-interlaced image is vertically low pass filtered prior to comparing the interpolated image at the selected location to the non-interlaced image.

According to another embodiment, the present invention provides a device for training a plurality of neural networks to deinterlace an image, wherein the device comprises: an interlacer configured to interlace a non-interlaced image and to communicate the interlaced image to a neural network, a vertical low pass filter configured to vertically low pass filter the non-interlaced image, a comparator configured to compare an interpolated value from the neural network to a corresponding value of the non-interlaced image from the vertical low pass filter and to provide an error signal representative of a difference between the interpolated value and the corresponding value, and a back propagation path configured to communicate the error signal from the comparator to the neural network to facilitate modification of the neural network.

These, as well as other features and advantages of the present invention, will be more apparent from the following description and drawings. It is understood that changes in the specific structure shown and described may be made within the scope of the claims, without departing from the spirit of the invention.

### BRIEF DESCRIPTION OF THE DRAWINGS

FIG. 1 shows a representative sample of an image having a distinct edge such that the edge direction is clearly defined thereby;

FIG. 2 shows an example functional block diagram for an edge direction and neural network based image deinterlacing system according to an embodiment of the present invention;

FIG. 3 shows a plurality of pixels defining a portion of a field of an interlaced image and the positions, i.e., pixels, where edge directions need to be detected;

FIG. 4 shows several representative edge directions and a numbering scheme for referring to the different edge directions;

FIGS. 5A and 5B show two different examples of vectors as used in a vector correlation method for finding edge directions;

FIG. 6 shows an original data set of neighboring pixels mirrored about a vertical line to form a mirrored data set such that the same neural network can be used for two different, but symmetrical (with respect to the vertical line), edge directions;

FIG. 7 shows an exemplary set of neighboring samples or pixels that are utilized in a neural network interpolator;

FIG. 8 shows an exemplary linear neural network that may be used as the neural network interpolator in an embodiment of the present invention;

FIG. 9 shows a system block diagram for training the neural network interpolators in an embodiment of the present invention;

FIG. 10 shows an exemplary frequency response of a low pass filter used to filter the training image to remove vertical high frequency components that are beyond the interpolation capability of the neural networks; and

FIG. 11 shows an example of a field being interpolated to facilitate explanation of why the neural network interpolator of the present invention is more robust and less sensitive to errors or inaccuracy in detected edge directions with respect to contemporary interpolation methods.

### DETAILED DESCRIPTION OF THE PREFERRED EMBODIMENTS

In one embodiment, the present invention provides a reliable and accurate spatial image interpolation method for deinterlacing and other applications. More particularly, the present invention provides an system for detecting edge directions between two neighboring scan lines in an interlaced image field and interpolating one omitted scan line at the center of the two neighboring scan lines using neural networks that are associated with edge directions. Through interpolation, the original interlaced image can generally be converted into a non-interlaced image without obvious artifacts or degradation around image edge areas.

Further, the present invention provides an edge direction based image interpolation method which is more stable and less sensitive to edge direction detection errors as compared to conventional methods of interpolation. In order to achieve this desirable result, neural networks are used in the interpolation process. For each different edge direction, a separate neural network is generally trained and used for interpolating pixels that have approximately that same edge direction at their locations.

For a given interlaced image, there is an omitted (missing) line between every two neighboring lines. According to the example embodiment herein for deinterlacing, edge directions are detected at pixel positions within each omitted line. The edge directions may be detected using any desired method, as long as the method can determine the edge direction between every two neighboring scan lines in an interlaced scan.

Each different edge direction is generally associated with a dedicated neural network. However, symmetrical edge directions (such as with respect to a vertical line) can be associated with the same neural network by using a simple mirror operation, as discussed in detail below.

The inputs to each neural network are the sample values of neighboring pixels of the new pixel. The output from the neural network is the interpolated value of the new pixel.

Training may be performed based on a set of standard test images. Each training image is preferably separated into two interlaced image fields and edge direction is detected at the location of the omitted line between every two neighboring lines in an image field. Based on the detection result, pixels with the same edge direction are grouped together. The pixel's neighboring sample values are then used as inputs to the corresponding neural network, wherein the neural network has been designated for interpolating when that particular edge direction is detected.

Preferably, the training target of the neural network is not the original values of the pixels to be interpolated. Instead, the original image is processed using a low pass filter (LPF) along the vertical direction, to remove vertical high frequencies that are beyond the interpolation capability according to sampling theory. The cut-off frequency of the low pass filter is preferably set to one forth of the sampling frequency of the current image. For the omitted pixels being interpolated, their values in the vertically low pass filtered image are considered as training target. Once training is completed, the neural network can be used as the interpolator for interpolating pixels with the corresponding edge direction.

The present invention combines the advantages of both edge direction based image interpolation method and neural networks for interpolation. This provides better edge quality to the interpolated image than conventional image interpolation methods that do not use edge directions. In addition, the present invention is more robust and less sensitive to errors or inaccuracy in the detected edge directions, than conventional methods.

Referring now to FIG. 1, a portion of an image having a readily discernable edge direction is shown. Along the edge direction, the values (e.g., luminance or alternatively, the color values or any other desired values) of pixels remain substantially constant or only change gradually. Conversely, across the edge direction, the luminance values of the pixels change sharply. Thus, the edge direction of the image portion shown in FIG. 1 is in the direction of the arrow.

As those skilled in the art will appreciate, such an edge represents boundaries within the image. For example, an edge may represent the boundary between a brightly illuminated item in the foreground of an image and a dark background, such as an edge of a white building against a dark night sky.

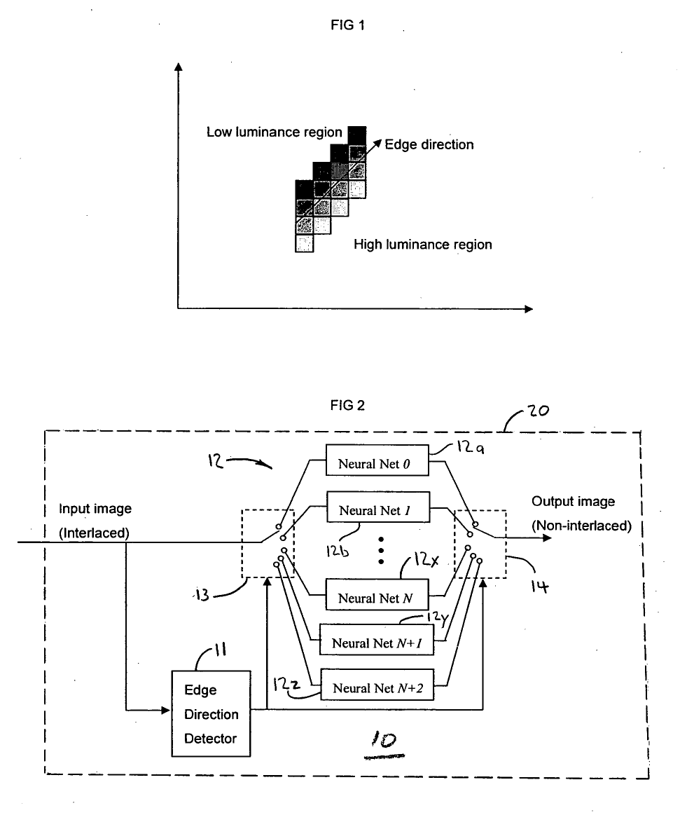

FIG. 2 shows a block diagram of an example system 10 for interpolation according to the present invention, comprising an edge direction detector 11 and a neural network based image interpolator 12. The image interpolator 12 comprises a plurality of individual neural networks 12a-12z. The number of individual neural networks 12a-12z corresponds approximately to the number of edge directions that the edge direction detector 11 is capable of detecting, or alternatively corresponds approximately to one half of that number, as discussed in further detail below.

The system 10 also comprises input and output switches, 13 and 14 respectively, that are both controlled by an output from the edge direction detector 11. The input and output switches 13 and 14 are synchronized with each other and thus always provide connection to the same neural networks 12a-12z. The selection position of the switches 13 and 14 depends on the edge direction detection result at the location of a new pixel which is to be interpolated. In this manner, a corresponding one of the neural network 12a-12z is selected for interpolating the value of each new pixel.

In practice (as opposed to training), the input to the system 10 is an interlaced image. The output from the system 10 is the processed image that is converted to non-interlaced format through interpolation. Thus, the input can be an interlaced image from any desired source and the output can then be used to display the image upon a digital television, computer monitor, or the like.

As shown in FIG. 2, system 10 may be disposed within a digital television or computer monitor 20, if desired. Alternatively, the system 10 may be incorporated into and/or disposed within a general purpose computer, a dedicated enclosure, or any other enclosure or device 20.

Referring now to FIG. 3, a portion of an interlaced field is shown comprising scan lines n−3, n−1, n+1 and n+3. The edge direction detector 11 (FIG. 2) detects edge directions at the center position between every two neighboring scan lines in an interlaced scan. Lines n−3, n−1, n+1 and n+3 are the original scan lines, prior to interpolation or deinterlacing. Solid circles 31 denote the original samples on scan lines n−3, n−1, n+1, n+3 in the field. Lines n−2, n and n+2 are the missing/omitted scan lines in the field (immediately preceding) and thus need to be interpolated. Hollow circles 32 denote the positions of new pixels to be interpolated. The positions 32 are the locations where the edge direction detector 11 needs to detect edge directions.

By adding interpolated pixels 32 to an image with pixels 31, an enhanced or deinterlaced image is generated. Although the present invention is particularly well suited for deinterlacing video images, those skilled in the art will appreciate that the present invention may similarly be utilized in a variety of different image resolution enhancement applications.

There are different ways of detecting edge directions in an image. For explanatory purposes, an example method for edge direction detection is used below in describing an embodiment of the present invention. However, other edge direction detection methods may also be used according to the present invention. Thus, such description is by way of example only, and not by way of limitation.

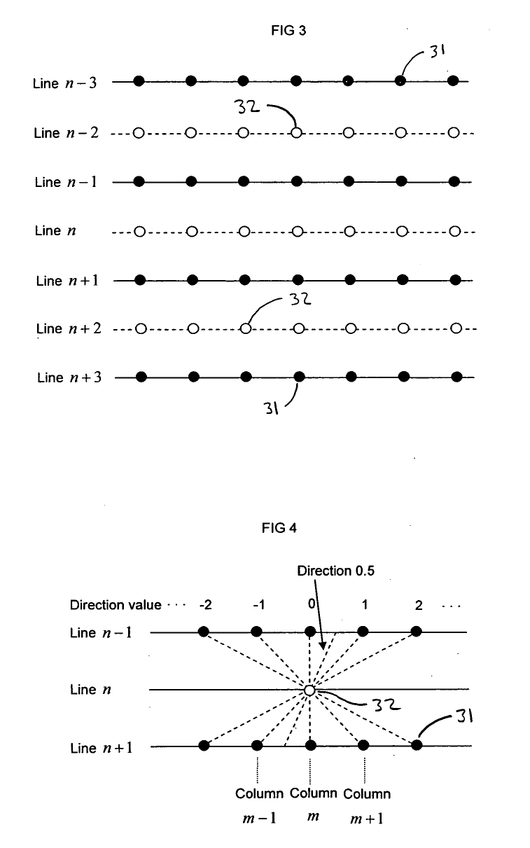

Referring now to FIG. 4, for explanatory purposes a numbering scheme is defined to represent different edge directions. Different schemes for designating edge directions may also be used.

The edge direction detector 11 may be hard-wired, or otherwise in communication, with the neural networks 12a-12z, or the first and second switches 13 and 14, such that explicit designation of the edge directions is not required. For example, detection of an edge direction by the edge direction detector 11 may result in selection of a corresponding neural network 12a-12z by positioning input and output switches, 13 and 14, via dedicated control lines connected thereto, thus obviating the need for an explicit numbering scheme.

Thus, as shown in FIG. 4, different edge orientations may be assigned to different numerical values. The vertical direction may be assigned a value of zero, for example. For a non-vertical direction, the value may be associated with the number of pixels shifted from the vertical direction on the upper row or lower row of the current pixel. For example, the direction connecting pixel (n+1,m−1) and pixel (n−1,m+1) may be assigned a value of 1. The direction connecting pixel (n+1,m+1) and pixel (n−1,m−1) may be assigned a value of −1. In a general form, the direction connecting pixel (n+1,m−i) and pixel (n−1,m+i) may be assigned a value of i. Here i can take both positive and negative values, or be a non-integer value. For example, FIG. 4 shows the direction with a value of 0.5 which connects the position (n+1,m−0.5) and position (n−1,m+0.5).

Preferably, one of the neural networks 12a-12z which most closely corresponds to the detected edge direction is used for interpolation. Thus, for example if neural networks 12a-12z are limited to providing interpolation for edge directions having only positive and negative integer values, and the detected edged direction is 1.2, then this value is rounded to the integer value of 1 and the neural network corresponding to this integer value is used for interpolation.

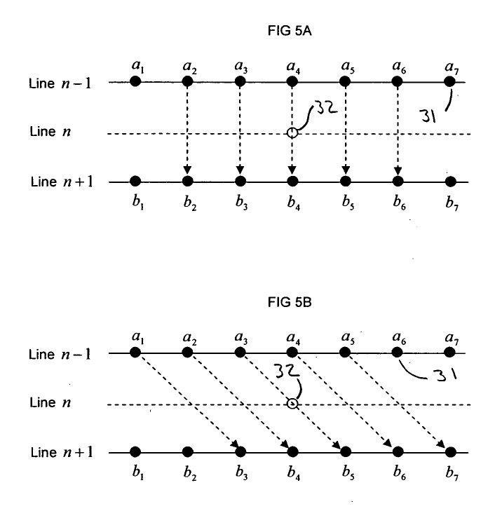

Referring now to FIGS. 5A and 5B, an exemplary method described herein for detecting edge directions by checking vector correlations is shown. A vector comprises a plurality of adjacent pixels on a selected scan line. A vector from one of two selected scan lines is correlated with respect to a vector from another selected scan line to determine edge direction. Pixels having approximately the same values have a comparatively high correlation with respect to one another. The direction defined by matching the pixels of one scan line to the pixels of another scan line is the edge direction, as discussed in detail with respect to the examples below.

An example of one set of possible correlations is shown in FIG. 5A. This set of correlations is for the vertical edge direction. Thus, if this set of correlations is the highest of all the sets of correlations checked, then the edge direction is vertical. In this example, the correlation of each pixel in the top scan line n−1 with each pixel immediately below in the bottom scan line n+1 is determined.

In FIG. 5A a hollow circle 32 denotes a pixel on the line n to be interpolated. Assume that the seven pixels 31 on line n−1 have values of a₁, a₂ , . . . , a₆ and a₇, respectively, and the seven pixels on line n+1 have values, of b₁, b₂, . . . , b₆ and b₇ respectively. Assume that the vector width (the number of pixels in each row that are used to define the vector) is 5. Then (a₂,a₃,a₄,a₅,a₆) defines a vector and (b₂,b₃,b₄,b₅,b₆) also defines a vector.

Checking the correlation between the two vectors facilitates a determination of the edge direction in the area of the image proximate the pixel 32 being interpolated. As mentioned above, if the pixels on the top line n−1 correlate best with the pixels directly below them, this indicates a vertical edge direction. However, it is important to appreciate that a plurality of different correlations are determined and the vector pairs which provide the best correlation are those which define the edge direction.

Similarly, as shown in FIG. 5B, checking the correlation between vector (a₁,a₂,a₃,a₄,a₅) and vector (b₃,b₄,b₅b₆,b₇) provides a correlation value for the −1 edge direction. If this set of correlations is the highest of all the sets of correlations checked, then the edge direction is −1.

In a like fashion, vector correlations can be checked along other directions. The direction that provides the best vector correlation is likely to indicate the real edge direction. An example vector correlation method is described in U.S. patent application Ser. No. 10/269,464, Attorney Docket SAM2.0011, entitled: “METHOD OF EDGE DIRECTION DETECTION BASED ON VECTOR CORRELATIONS AND THE APPARATUS THEREFOR”, filed on Oct. 11, 2002, incorporated herein by reference,

Referring now to FIG. 6, a mirroring operation may optionally be used to reduce (approximately halve) the number of neural networks 12a-12z required to process a given number of edge directions. After edge direction detection, pixels with a given edge direction are interpolated using the appropriate neural network interpolator. The appropriate neural network interpolator is that neural network which has been trained for the given edged direction. Generally, each neural network 12a-12z is thus dedicated to a single edge direction.

Each pair of edge directions that are symmetrical to each other relative to the vertical direction can be grouped together by simply using a horizontal mirror operation. Therefore, pixels with edge directions of e.g. k or −k can share the same neural network interpolator.

For example, if the neural network interpolator is trained for interpolating pixels with an edge direction of k and an edge with a direction of −k is identified at the current pixel location, then the neighboring samples of the current pixel are optionally mirrored about a vertical line before they are sent to the neural network interpolator. After such mirroring, an edge with a direction of −k becomes an edge with a direction of k. Thus, a single neural network, suitable for interpolating an edge with a direction of k, can interpolate for both edge directions of k and −k.

Referring now to FIG. 6, assume that the neighboring pixels utilized in the interpolator include the 5×4 group of neighboring samples or pixels as shown. In this figure, the current sample is denoted by the hollow circle with a small cross inside circle 41. The data before and after mirroring the samples about a vertical line operation is shown. The samples are reversed left-to-right after the mirroring operation. This results in any edge direction similarly being reverse, which results in a change of sign of any non-horizontal or non-vertical edge direction.

Assume that the edge direction detector 11 (FIG. 2) can distinguish a number of 2N+1 different edge directions including the vertical direction. Through the mirror operation, these directions can be grouped into N+1 cases by combining every two symmetrical directions into one case. In addition, the edge direction detector 11 is preferably able to distinguish two additional cases. One case is that of a flat image area, i.e., an image area with no edge (e.g., an all white image area has no edge).

The other case is where no valid edge direction can be detected in the image area, such as when the image area content is too complex, i.e., has too fine of structures contained therein to be discernable as an edge (e.g., a mottled portion of the image may give this result, if the mottling is fine enough).

Including these two cases (flat image and complex image), the total number of cases that the edge direction detector 11 is capable of determining is N+3. Therefore, N+3 neural network interpolators 12a-12z are needed in the system 10, as shown in FIG. 2.

The neural network interpolators 12a-12z used in the system 10 can be either linear or non−linear. Indeed, neural networks having a wide range of characteristics can be used. The inputs for each neural network interpolators 12a-12z are the neighboring samples of the current pixel on a missing scan line of an image field. The output is the interpolation value for the current pixel.

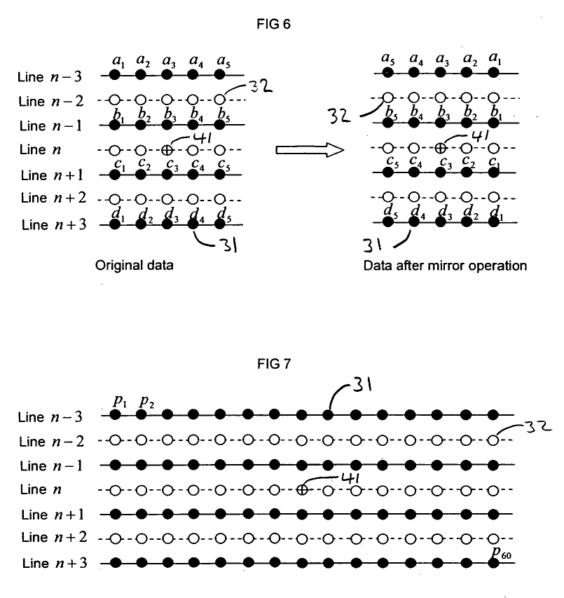

Referring now to FIG. 7, the neighboring 15×4 samples of the current pixel are used for the interpolation. These samples serve as the input to the neural network interpolator. In FIG. 7, the positions of the 15×4 neighboring samples are shown as the solid circles 31. The sample values are denoted as p₁,p₂, . . . . p₆₀ respectively from the top left corner to the bottom right corner of this area. The pixels of the missing scan lines are shown as hollow circles 32. The hollow circle 41 with a small cross in the center represents the current pixel to be interpolated.

Once the edge direction is detected, interpolation for a new pixel is performed through a set of neural network interpolators. Each neural network interpolator is responsible for interpolating pixels with a different edge direction. Referring now to FIG. 8, the structure of an example linear neural network 12 that can be used in system 10 (FIG. 2) is shown, wherein there is only one linear neuron. Alternatively, each neural network 12a-12z may comprise any desired number of nonlinear neurons coupled in any desired configuration. For simplicity, a linear neural network is selected for the interpolation. The input for each neural network interpolator is the neighboring samples of the current pixel. The output is the interpolation value for the current pixel. For example, the neighboring 15×4 samples of the current pixel in an interlaced image can be used as the network input. The sample values are denoted as p₁,p₂, . . . p_{L} respectively from the top left corner to the bottom right corner of the neighboring area.

The nodes p₁,p₂, . . . p_{L} in FIG. 8 are the inputs to the neural networks 12a-12z, and q is the output. A bias value is preferably initially set to 0. The output q is generated by a linear transfer function block 81. Since the linear transfer function 81 simply returns the value passed to it, the linear transfer function can optionally be omitted in implementations of the present invention. The relationship between the output q and input of the neural networks 12a-12z can be expressed as follows:

$$q = {\sum }_{i = 1}^{L} {p}_{i} {w}_{i}$$

wherein w₁,w₂, . . . w_{L} in the above equation are weighting coefficients (weighting parameters), and L in the equation indicates the number of neighboring samples used in interpolation (for the case shown in FIG. 7, L is equal to 60). As those skilled in the art will appreciate, the weighting coefficients are the key parameters in determining the characteristics of a neural network interpolator. Different edge directions require different weighting coefficients for optimal results. Thus, different neural network interpolators generally have different weighting coefficients.

The example in FIG. 8 shows the case when a linear neuron is used. When there is only one output from the neural network, one linear neuron is sufficient. This is because in this case, a network with more than one linear neurons is essentially equivalent to a network with one linear neuron. When nonlinear neurons are used, more than one neuron can be included in the network. FIG. 8 provides an exemplary neural network that can be used in this system. However, nonlinear neural networks with one or more neurons can also be used. Regardless of the type of neural network, the same training method described below can be applied.

The inventors have found that the 60 neighboring samples shown in FIG. 7 are sufficient for providing good interpolation results with reasonable network training complexity. Either too small or too large of a neighborhood is not desired since either will result in less than optimal interpolation results. When L is too small, the correlation of neighboring sample values can not be fully utilized. When L is too large, it is difficult to train the neural network so as to obtain an optimal set of weighting parameters.

For each different result from the edge direction detector 11, a separate neural network 12a-12z, is selected and used for interpolation, such as that shown in FIG. 8. If desired, symmetric results may be processed by the same neural network as discussed above. For example, referring back to FIG. 2, assume that the edge direction detector 11 can determine a number of (2*N+1) different edge directions including the vertical direction. Then, there are a total of N+3 neural network interpolators needed for the system 10. The output from the edge direction detector can be classified into four cases: (1) Vertical direction, (2) 2*N different non-vertical directions, (3) Flat image area with no edge and (4) Complex image area with no valid edge. One neural network interpolator is needed for case (1), (3) and (4) respectively. But for the case of non-vertical directions, only N neural network interpolators are enough. This is because through a horizontal mirror operation on the neighboring samples, the 2*N non-vertical directions can be grouped into N groups by combining every two symmetrical directions into one group. For example, directions with a value of k and −k can be grouped together and share one network. In this way, a total of N+3 neural network interpolators are sufficient for the system 10.

Before a neural network can be used for interpolation, it generally must be trained so that an optimal set of weighting parameters w₁,w₂, . . . w_{L} can be determined. That is, each neural network must be trained so as to determine the optimal weighting parameters for the particular edge direction for which that particular neural network is to interpolate.

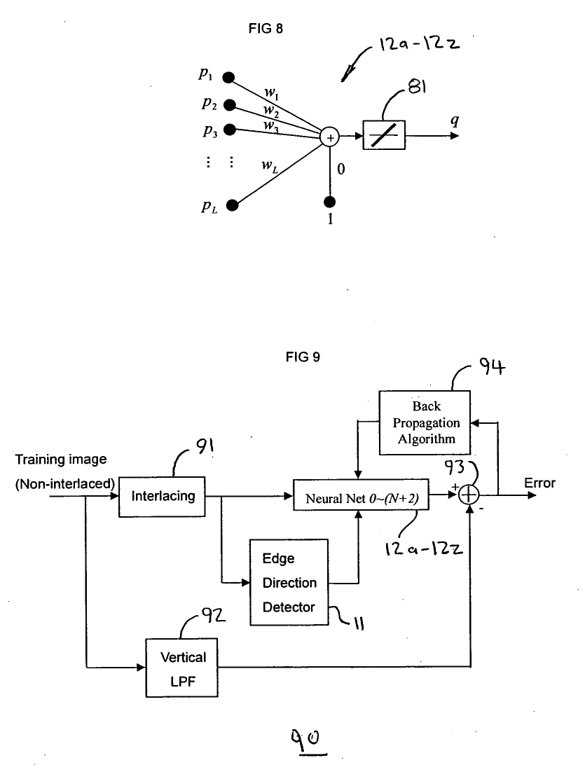

Referring now to FIG. 9, an example block diagram of a system 90 for the training process is shown. In this system 90, the input is preferably a non-interlaced training image. The output is the neural network learning error. Each training image is preferably interlaced into two fields. In each field, edge directions are preferably detected at the position of every omitted pixel by the edge direction detector 11. The edge direction detector 11 in FIG. 9 is preferably the same edge direction detector 11 as that shown in FIG. 2 and described above. Based on the output from the edge direction detector 11, a corresponding neural network 12a-12z is selected. The neighboring sample values of the omitted pixel are used as the neural network inputs.

The original training image is preferably processed through a vertical low pass filter (LPF) 92. This filter 92 is used to remove that portion of the vertical high frequency which is beyond the reliable interpolation capability of the neural networks 12a-12z, according to sampling theory. Thus, the cut-off frequency of the low pass filter is preferably one-fourth of the sampling frequency of the training image.

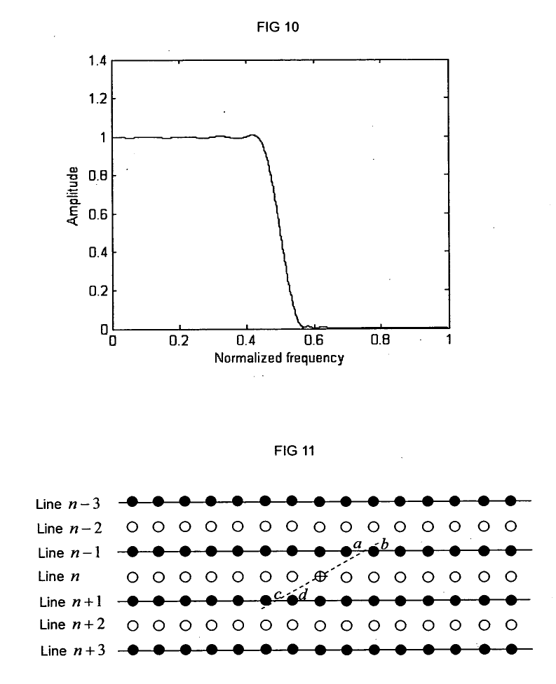

Referring now to FIG. 10, an example frequency response of a low pass filter is shown where a normalized frequency value of 1 corresponds to half of the sampling frequency.

Referring again to FIG. 9, after vertical low pass filtering, the corresponding value for the omitted pixel is used as the training target. The output of the neural network 12a-12z is compared with the training target by combiner 93. The error between the training target and the output of the neural network 12a-12z is determined and provided via back-propagation algorithm block 94 to the neural network 12a-12z which is being trained. Error calculation is preferably based upon a least mean square (LMS) procedure according to well known principles. The weighting coefficients of the neural network 12a-12z are adjusted to so as to minimize the error. The bias factor of the neural network 12a-12z may also be varied so as to minimize the error, if desired.

Such a training process is conducted in an iterative manner. The process continues until the error drops below a predetermined threshold or the number of iterations reaches a predetermined value. The process is repeated for each individual neural network 12a-12z. After the training process is finished for all the neural networks shown in FIG. 2, then the apparatus of the present invention is ready to be used for image interpolation.

The example method described in the present invention utilizes both edge direction detection and neural networks for image interpolation. Through edge direction detection, pixels with the same edge direction can be classified into the same group so that a specific interpolator may be used to better preserve edge characteristics in that direction. In the neural network interpolator, more neighboring samples are used for interpolating the current pixel value than are used according to contemporary methodology, which uses only the neighboring samples along the edge direction for interpolation. Using more neighboring samples in interpolation makes the present method more robust and less sensitive to errors or inaccuracy in the detected edge directions as compared to contemporary methods.

Referring now to FIG. 11, an example of edge detection and interpolation according to the present invention shows advantages of the present invention. Assume, for example, that the real edge direction at the current pixel location is 1.7 according to the exemplary scheme for designating edge directions discussed above.

The edge direction would typically be detected as 2. However, interpolating along edge direction 2 may not give good results, because pixels a and d are not utilized in the interpolation and pixels b and c are not aligned with the real edge direction. However, utilizing the neural network interpolator described in the present invention, more neighboring samples, including a, b, c, d, are used in interpolation. Therefore, the present invention provides good interpolation results even when the edge direction is not accurately detected.

According to the present invention, a robust method for interpolating images which is suitable for video deinterlacing is provided. The method of the present invention maintains image quality even when edge direction detection is inaccurate and thus overcomes limitations of contemporary interpolation methodologies which are due to inherent limitations in the edge direction detection process.

It is understood that the exemplary method and apparatus for image deinterlacing described herein and shown in the drawings represents only a presently preferred embodiment of the invention. Various modifications and additions may be made to such embodiments without departing from the spirit and scope of the invention. For example, the neural networks may be simulated neural networks, such as via computer code, rather than actual neural networks.

Thus, these and other modifications and additions may be obvious to those skilled in the art and may be implemented to adapt the present invention for use in a variety of different applications.

1. A method for spatially interpolating an image, the method comprising using the steps of a dedicated neural network for each of a plurality of different edge directions to provide an interpolated value of the image.

2. A method for spatially interpolating an image, the method comprising training a neural network to interpolate for an edge direction and then using that neural network to interpolate when approximately the same edge direction is determined.

3. A method for spatially interpolating an image, the method comprising associating a plurality of neural networks with a corresponding plurality of edge directions by training each neural network to interpolate a value based upon the associated edge direction.

4. A method for spatially interpolating an image, the method comprising the steps of:
determining an edge direction of an image at a location within the image where interpolation is desired;
selecting a neural network based upon the determined edge direction; and
interpolating a value of the image at the location using the selected neural network.

5. The method as recited in claim 4, wherein determining an edge direction comprises determining vector correlations between pixels on adjacent scan lines such that the location where interpolation is desired is between the adjacent scan lines.

6. The method as recited in claim 4, further comprising determining whether or not a viable edge direction exists, prior to selecting a neural network and when no viable edge direction exists, then selecting a neural network which was trained to interpolate when no viable edge direction exists.

7. The method as recited in claim 4, wherein selecting a neural network comprises the steps of determining which of a plurality of different neural networks is most closely associated with the determined edge direction.

8. The method as recited in claim 4, wherein selecting a neural network comprises the steps of determining which of a plurality of different neural networks is best trained to interpolate a value of the image for the determined edge direction.

9. The method as recited in claim 4, wherein selecting a neural network comprises the steps of mirroring a data set to facilitate use of a common neural network for symmetric edge directions.

10. The method as recited in claim 4, wherein selecting a neural network comprises the steps of vertically mirroring a data set to facilitate use of a common neural network for symmetric edges.

11. The method as recited in claim 4, wherein selecting a neural network comprises the steps of selecting a substantially linear neural network with one neuron.

12. The method as recited in claim 4, further comprising the steps of training a plurality of neural networks, wherein each neural network is trained to interpolate a value of an image for a predetermined edge direction.

13. The method as recited in claim 4, further comprising the steps of repeating the determining, selecting and interpolating steps so as to provide a new scan line between two old scan lines.

14. The method as recited in claim 4, further comprising repeating the determining, selecting and interpolating steps so as to provide a new scan line between two old scan lines in order to facilitate deinterlacing.

15. The method as recited in claim 4, wherein the location where interpolation is desired is defined by a pixel in the image.

16. The method as recited in claim 4, wherein the interpolated value is intensity.

17. The method as recited in claim 4, wherein the interpolated valued is color.

18. The method as recited in claim 4, wherein the edge direction is determined by correlating at a vector from one scan line proximate the location where interpolation is desired with a vector from another scan line proximate the location where interpolation is desired.

19. The method as recited in claim 4, wherein the edge direction is determined by correlating at a vector from a scan line immediately above the location where interpolation is desired with a vector from another scan line immediately below the location where interpolation is desired.

20. The method as recited in claim 4, wherein the location where interpolation is desired is between two scan lines of a video image.

21. The method as recited in claim 4, wherein the location where interpolation is desired is between two scan lines of a field of an interlaced video image.

22. The method as recited in claim 4, wherein the location where interpolation is desired is approximately centered between two scan lines of an interlaced video image.

23. The method as recited in claim 4, wherein the location where interpolation is desired is approximately centered between two scan lines of an interlaced video image and further comprising enhancing the video image with the interpolated value so as to facilitate formation of a deinterlaced video image.

24. The method as recited in claim 4, wherein inputs to the selected neural network comprise values of neighboring portions of the image with respect to the location where interpolation is desired.

25. The method as recited in claim 4, wherein inputs to the selected neural network comprise values of neighboring pixels with respect to a pixel at the location where interpolation is desired.

26. The method as recited in claim 4, wherein:
determining an edge direction comprises selecting one of 2N+1 different edge directions;
selecting a neural network comprises selecting one of N+3 neural networks; and
N+1 of the neural networks are used for interpolation when an edge direction can be configuring determined, and one of the neural networks is used for interpolation when an edge exists and the edge direction cannot be determined, and one neural network is used when there is no edge.

27. The method as recited in claim 4, wherein between approximately 40 and approximately 80 samples are provided as inputs to the neural network.

28. The method as recited in claim 4, wherein approximately 60 samples are provided on inputs to the neural network.

29. The method as recited in claim 4, wherein the neural network is trained.

30. The method as recited in claim 4, further comprising training the neural network by providing a portion of an image to the neural network.

31. The method as recited in claim 4, further comprising training the neural network by providing a portion of an image to the neural network with the weighting coefficients initially set to zero.

32. The method as recited in claim 4, further comprising training the neural network by providing a portion of an image to the neural network with a bias value initially set to zero.

33. The method as recited in claim 4, further comprising training the neural network by providing a vertically low pass filtered portion of an image to the neural network.

34. The method as recited in claim 4, further comprising training the neural network by providing a portion of an image to the neural network, the portion of the image being low pass filtered along a vertical direction to mitigate vertical components which are substantially beyond a capability of the neural network to interpolate.

34. The method as recited in claim 4, further comprising training the neural network by providing a portion of an image to the neural network, the portion of the image being low pass filtered with a cut-off frequency of approximately one fourth of a sampling frequency of the image.

35. The method as recited in claim 4, further comprising training the neural network by providing a portion of an image to the neural network and using a back propagation algorithm to vary parameters of the neural network.

36. The method as recited in claim 4, further comprising training the neural network by providing a portion of an image to the neural network and using a back propagation algorithm to vary parameters of the neural network, the back propagation algorithm using a least mean square procedure as a learning algorithm.

37. A system for spatially interpolating an image, the system comprising a dedicated neural network configured to provide an interpolated value for each of a plurality of different edge directions in the image.

38. A system for spatially interpolating an image, the system comprising:
a plurality of neural networks, each neural network configured to interpolate a value of the image for a predetermined edge direction;
an edge direction detector configured to determine an edge direction of an image at a location within the image where interpolation is desired; and
a neural network selector responsive to the edge direction detector and configured to select one of the neural networks based upon the determined edge direction.

39. The system as recited in claim 38, wherein the edge direction detector is configured to determine an edge direction by determining vector correlations between pixels on adjacent scan lines wherein the location is between the adjacent scan lines.

40. The system as recited in claim 38, wherein the edge direction detector is configured to determine whether or not a viable edge direction exists prior to selecting a neural network and when no viable edge direction exists then selecting a neural network which was trained to interpolate when no viable edge direction exists.

41. The system as recited in claim 38, wherein the neural network selector is configured to select a neural network by determining which of a plurality of different neural networks is most closely associated with the determined edge direction.

42. The system as recited in claim 38, wherein the neural network selector is configured to select a neural network comprises determining which of a plurality of different neural networks is best trained to interpolate a value of the image for the determined edge direction.

43. The system as recited in claim 38, wherein the edge direction detector is configured to mirror a data set to facilitate use of a common neural network for symmetric edge directions.

44. The system as recited in claim 38, wherein the edge direction detector is configured to vertically mirror a data set to facilitate use of a common neural network for symmetric edges.

45. The system as recited in claim 38, wherein the neural network comprises a substantially linear neural network with one neuron.

46. The system as recited in claim 38, wherein each neural network is trained to interpolate a value of an image for a predetermined edge direction.

47. The system as recited in claim 38, wherein the edge direction detector is configured to determine an edge direction by correlating at a vector from one scan line proximate the location where interpolation is desired with a vector from another scan line from proximate the location where interpolation is desired.

48. The system as recited in claim 38, wherein the edge direction detector is configured to determined an edge direction by correlating a vector from a scan line immediately above the location where interpolation is desired with a vector from another scan line immediately below the location where interpolation is desired.

49. A method for interpolating an omitted scan line between two neighboring scan lines of an interlaced image, the method comprising detecting an edge direction of the image at a selected point on the omitted scan line, selecting a neural network based upon the detected edge direction, and using the neural network to provide an interpolated value for the selected point.

50. A method for deinterlacing a video image, the method comprising:
determining an edge direction of a video image at a location within the video image where interpolation is desired, the location being intermediate two adjacent scan lines of a field of the video image;
selecting a neural network based upon the determined edge direction; and
interpolating a value of the video image at the location using the selected neural network.

51. The method as recited in claim 50, further comprising repeating the determining, selecting and interpolating steps so as to provide a new scan line between two old scan lines.

52. A device for interpolating an omitted line between two neighboring scan lines of an interlaced image, the device comprising an edge detector configured to detect an edge direction of the image at a selected point on the omitted line, and a plurality of neural networks, each neural network configured to interpolate a value for the omitted line when a particular edge direction has been detected.

53. A system for deinterlacing a video image, the system comprising:
a plurality of neural networks, each neural network configured to interpolate a value of the video image for a predetermined edge direction;
an edge direction detector configured to determine an edge direction of an image at a location within the video image where interpolation is desired; and
a neural network selector responsive to the edge direction detector and configured to select one of the neural networks based upon the determined edge direction.

54. A display monitor comprising:
a system for deinterlacing a video image, the system for deinterlacing a video image comprising:
a plurality of neural networks, each neural network configured to interpolate a value of the video image for a predetermined edge direction;
an edge direction detector configured to determine an edge direction of an image at a location within the video image where interpolation is desired; and
a neural network selector responsive to the edge direction detector and configured to select one of the neural networks based upon the determined edge direction.

55. An image produced using a method for spatial interpolation, the method for spatial interpolation comprising:
determining an edge direction of an image at a location within the image where interpolation is desired;
selecting a neural network based upon the determined edge direction; and
interpolating a value of the image at the location using the selected neural network.

56. A deinterlaced video image produced using a method for deinterlacing, the method for deinterlacing comprising:
determining an edge direction of an interlace video image at a location within the image intermediate two adjacent scan lines of a field of the video image;
selecting a neural network based upon the determined edge direction; and
interpolating a value of the video image at the location using the selected neural network.

57. A method for training a neural network, the method comprising:
providing a non-interlaced image;
interlacing the image to form an interlaced image;
providing at least a portion of the interlaced image to the neural network;
determining an edge direction in the interlaced image at a location within the interlaced image;
selecting a neural network based upon the determined edge direction;
interpolating a value of the interlaced image at the location using the selected neural network;
comparing the interpolated value with a value from a corresponding location of the non-interlaced image to define an error value; and
modifying the selected neural network based upon the error value.

58. The method as recited in claim 57, further comprising vertically low pass filtering the interlaced image prior to comparing the interpolated value with a value from the corresponding location of the non-interlaced image.

59. A device for training a plurality of neural networks to deinterlace an image, the device comprising:
an interlacer configured to interlace a non-interlaced image and to communicate the interlaced image to a neural network;
a vertical low pass filter configured to vertically low pass filter the non-interlaced image;
a comparator configured to compare an interpolated value from the neural network to a corresponding value of the non-interlaced image from the vertical low pass filter and to provide an error signal representative of a difference between the interpolated value and the corresponding value; and
a back propagation path configured to communicate the error signal from the comparator to the neural network to facilitate modification of the neural network.

60. A medium for storing information, the medium having stored thereon a method for spatial interpolation, the method for spatial interpolation comprising:
determining an edge direction of an image at a location within the image where interpolation is desired;
selecting a neural network based upon the determined edge direction; and
interpolating a value of the image at the location using the selected neural network.

61. A medium for storing information, the medium having stored thereon an image produced using a method for spatial interpolation, the method for spatial interpolation comprising:
determining an edge direction of an image at a location within the image where interpolation is desired;
selecting a neural network based upon the determined edge direction; and
interpolating a value of the image at the location using the selected neural network.
